(19) United States
(12) Patent Application Publication
(10) Pub. No.: US 2010/0202098 A1
(43) Pub. Date: Aug. 12, 2010

(54) CERAMIC ELECTRONIC PART

(75) Inventors: Miyuki YANAGIDA, Tokyo (JP); Taketo Sasaki, Tokyo (JP); Satoshi Kurimoto, Tokyo (JP); Masahiko Konno, Tokyo (JP); Yuki Morita, Tokyo (JP); Hisayuki Abe, Tokyo (JP)

Correspondence Address: DRINKER BIDDLE & REATH (DC), 1500 K STREET, N.W., SUITE 1100, WASHINGTON, DC, 20005-1209, US

(73) Assignee: TDK Corporation, Chuo-ku (JP)

(21) Appl. No.: 12/686,651

(22) Filed: Jan. 13, 2010

(30) Foreign Application Priority Data
Jan. 16, 2009 (JP) P2009-007663

(51) Int. Cl. H01G 4/008; H01G 4/12

(52) U.S. Cl. 361/305; 361/321.1

(57) ABSTRACT

A ceramic electronic part 100 having a chip element 1 having internal electrodes embedded therein, and terminal electrodes 3 that cover the end faces 11 of the chip element 1 having an exposed internal electrode and parts of the side faces 13,15 orthogonal to the end faces 11, and that are electrically connected to the internal electrodes, wherein the terminal electrodes 3 include a first electrode layer and a second electrode layer with a lower glass component content than the first electrode layer, in that order from the chip element 1 side, the second electrode layer being formed covering part of the first electrode layer on the side faces 13,15.

### BACKGROUND OF THE INVENTION

1. Field of the Invention

The present invention relates to a ceramic electronic part.

2. Related Background Art

Ceramic electronic parts such as stacked ceramic capacitors comprising ceramic elements and terminal electrodes on their end faces are used in a wide variety of electronic devices. Recently, with downsizing and increasingly higher performance of electronic devices, demand continues to rise for smaller and higher capacity ceramic electronic parts.

Techniques proposed for ceramic electronic parts include forming the terminal electrodes of ceramic electronic parts by a built-up structure obtained by stacking a plurality of electrode layers with different compositions, in order to obtain a satisfactory soldering proper for mounting and a satisfactory bonding property between the ceramic elements and terminal electrodes (see Japanese Unexamined Patent Publication HEI No. 7-86080 and Japanese Unexamined Patent Publication No. 2003-243245, for example). The outermost layers of the terminal electrodes in such ceramic electronic parts are commonly stacked plating layers having Ni-plated layer and Sn-plated layer formed by electroplating, so as to prevent electrode erosion during the soldering for mounting of the ceramic electronic parts (see Japanese Unexamined Patent Publication No. 2003-243245, for example).

### SUMMARY OF THE INVENTION

In order to achieve high capacities for ceramic electronic parts it is preferred for the ceramic material to maximally maintain its original properties such as insulation resistance. However, corrosion by the plating solution and infiltration of moisture in the air during formation of ceramic electronic part plating layers can lower the insulation resistance of the ceramic electronic part. When the terminal electrode has a built-up structure, cracking or peeling can result due to differences in the sintering properties of each layer.

One method of preventing infiltration of plating solution into the interior of a ceramic electronic part involves increasing the thickness of the terminal electrodes at the corners and corner edges of the ceramic electronic part. Such methods, however, increase the overall thickness of the terminal electrodes and therefore increase the size of the product dimensions, making it difficult to satisfy the dimensional standards for the product. In the case of a chip capacitor, for example, increasing the thickness of the terminal electrodes requires the shape of the ceramic element to be reduced in size to satisfy the dimensional standards for the product, and this interferes with obtaining higher capacity and larger volume designs.

The present invention has been accomplished in light of these circumstances, and its object is to provide a ceramic electronic part that has excellent insulating reliability while maintaining product dimensions.

In order to achieve this object, the invention provides a ceramic electronic part comprising a chip element having internal electrodes embedded therein, and terminal electrodes that cover the end faces of the chip element having exposed internal electrodes and parts of the sides orthogonal to the end faces, and that are electrically connected to the internal electrodes, wherein the terminal electrodes comprise a first electrode layer and a second electrode layer with a lower glass component content than the first electrode layer, in that order from the chip element side, the second electrode layer being formed covering part of the first electrode layer on the side faces.

The ceramic electronic part of the invention has excellent insulating reliability. The present inventors believe the reason for this to be the following. The ceramic electronic part of the invention is provided with a second electrode layer having a low glass component content, covering only part of a first electrode layer having a high glass component content, on the side faces orthogonal to the end faces of the ceramic element. It is thus possible to reduce stress caused by the difference in shrinkage factor resulting from the difference in sintering properties of the electrode layers, compared to covering the entirety of the first electrode layer with a second electrode layer. As a result, it is possible to prevent peeling between the first and second electrode layers and cracking of the terminal electrodes. Furthermore, since the first electrode layer is provided not only on the end faces of the ceramic element but also covering part of the sides, it is possible, for example, to adequately prevent infiltration of plating solution near the end faces of the chip element when a plating layer is formed on the first and second electrode layers by plating treatment. The ceramic electronic part may be considered to exhibit excellent insulating reliability due to these factors.

With the ceramic electronic part of the invention it is possible to obtain reduced thickness for the terminal electrodes on the side faces, compared to forming a second electrode layer covering the entirety of the first electrode layer on the side faces of the ceramic element, thus allowing further size reduction and increased relative size of the ceramic element for higher capacity designs.

The terminal electrodes in the ceramic electronic part of the invention preferably have a third electrode layer that covers the first electrode layer and second electrode layer. If the ceramic electronic part has, for example, a plating layer as the third electrode layer, it will be possible to satisfactorily inhibit electrode erosion during mounting.

Each of the terminal electrodes in the ceramic electronic part of the invention preferably has the second electrode layer on the corner of the chip element. This structure can protect the corner of the ceramic element, which is normally prone to damage, by a second electrode layer with a low glass component content. Furthermore, because the glass component content of the second electrode layer is low, it is possible to sufficiently ensure adhesiveness between the second electrode layer and third electrode layer at the corner. The ceramic electronic part exhibits even more excellent insulating reliability as a result of these factors.

According to the invention, the second electrode layer is preferably formed at the corner edges between the side faces, that are orthogonal to the end faces and adjacent to each other, and extending toward the opposite end faces. This structure can protect the corner edges of the ceramic element, which are normally prone to damage, by the second electrode layer. Thus, it is possible to adequately inhibit infiltration of plating solution into the ceramic element when a third electrode layer is formed using a plating solution, and to obtain a ceramic electronic part with even more excellent insulating reliability.

The terminal electrodes of the ceramic electronic part of the invention preferably contain one or more elements selected from among Cu, Ag, Pd, Au, Pt, Fe, Zn, Al, Sn and Ni. It will thereby be possible to obtain a ceramic electronic part with terminal electrode conductivity more satisfactorily assured.

According to the invention it is possible to provide ceramic electronic parts having excellent insulating reliability while maintaining product dimensions.

### BRIEF DESCRIPTION OF THE DRAWINGS

FIG. 1 is a perspective view of a preferred embodiment of a ceramic electronic part of the invention. FIG. 2 is a cross-sectional view schematically showing a cut surface of the ceramic electronic part of FIG. 1 along line II-II. FIG. 3 is a cross-sectional process diagram schematically showing the conductive paste bonding step and the conductive sheet attachment step. FIG. 4 is an oblique view of a chip component 110 having fired electrode layers 8 formed on both end faces of a chip element 1. FIG. 5 is a cross-sectional view schematically showing a cut surface of the chip component 110 of FIG. 4 along line V-V. FIG. 6 is a cross-sectional view schematically showing a cut surface of the chip component 110 parallel to the end faces 11, and running through ends of the internal electrodes 9 that are not exposed at the end faces.

### DETAILED DESCRIPTION OF THE PREFERRED EMBODIMENTS

Preferred embodiments of the invention will now be explained with reference to the accompanying drawings where necessary. Throughout the explanation of the drawings, identical or corresponding elements will be referred to by like reference numerals and will be explained only once.

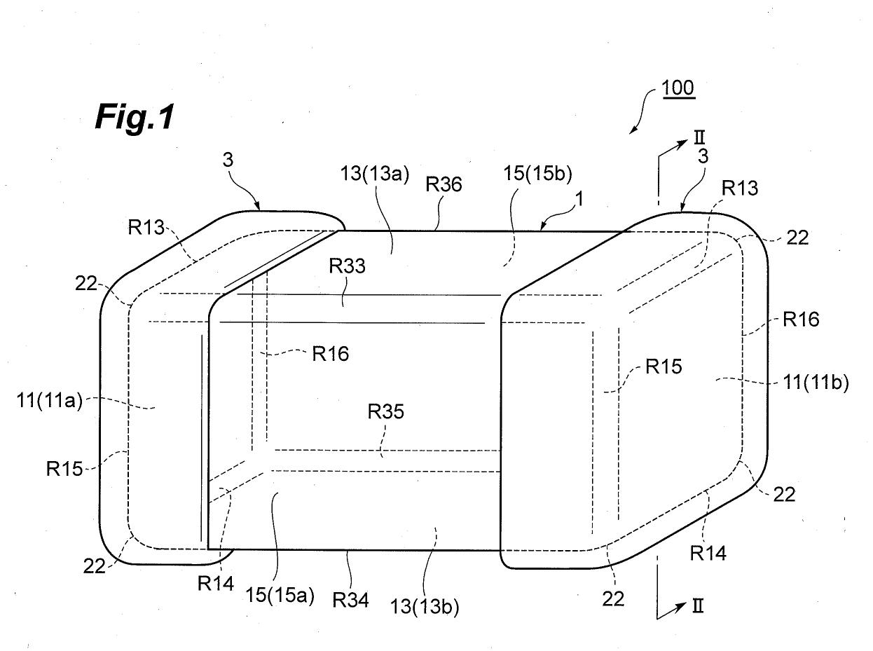

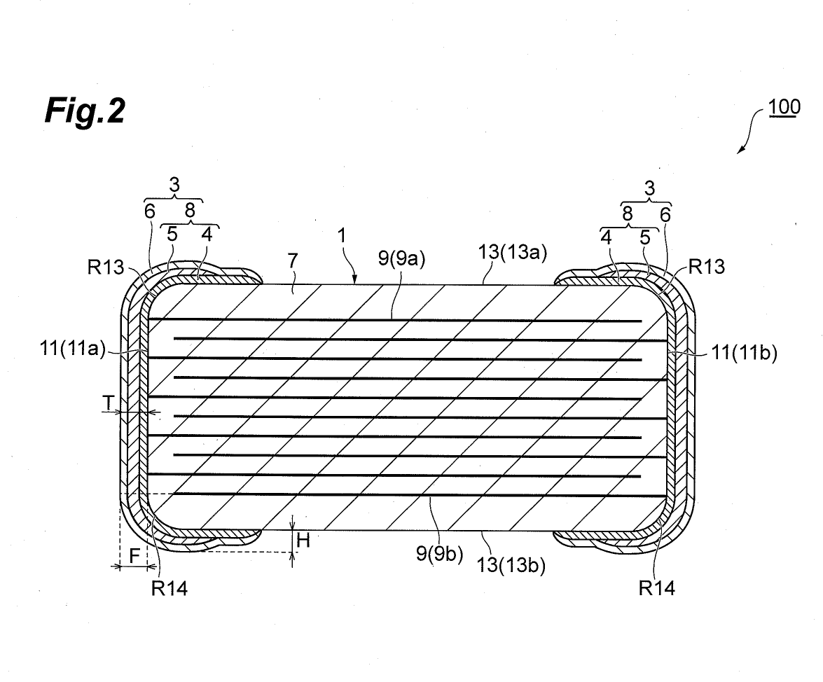

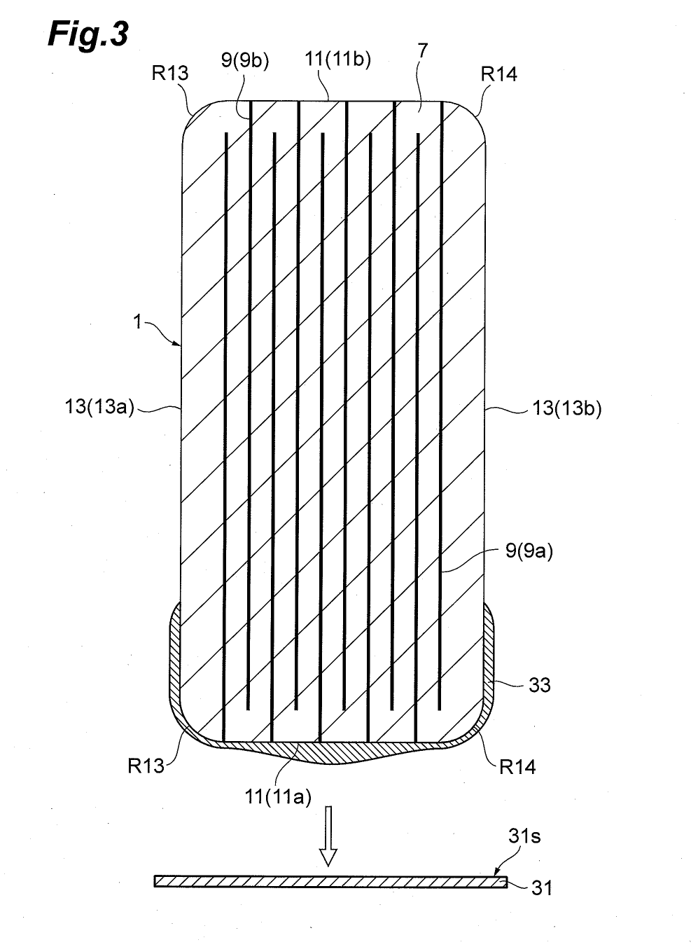

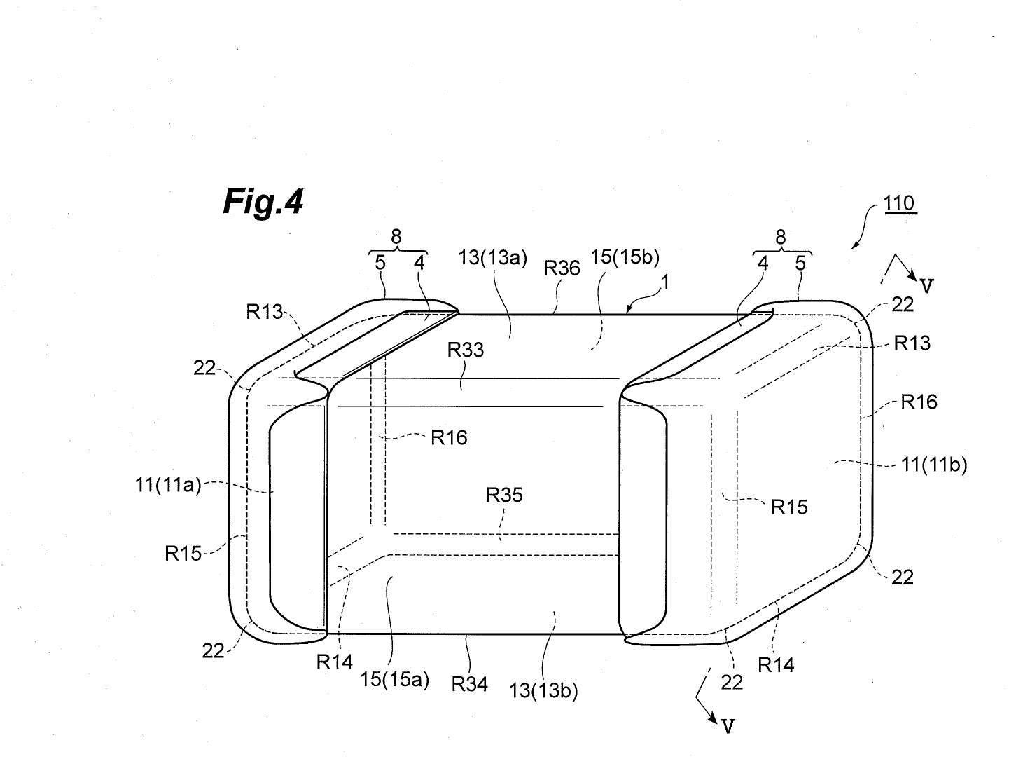

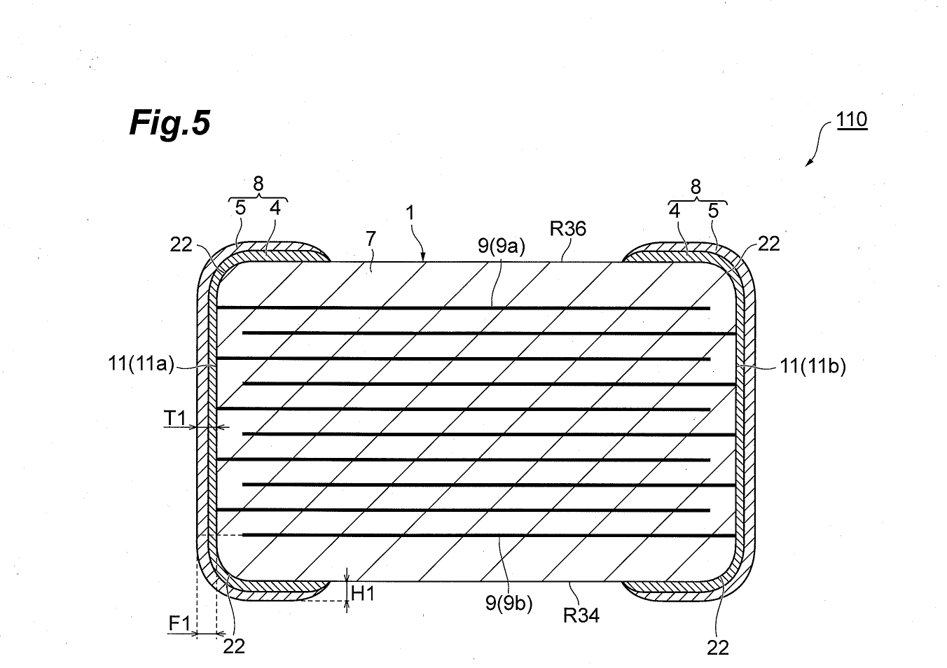

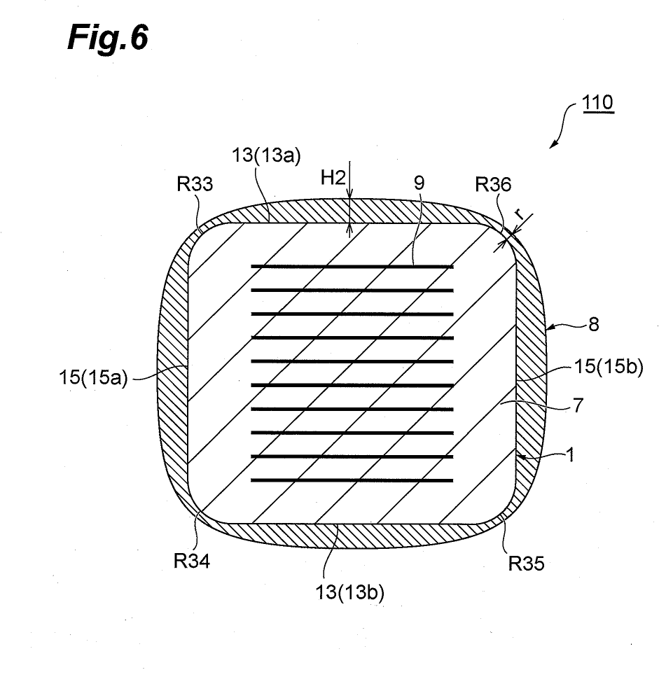

FIG. 1 is a perspective view of a preferred embodiment of a ceramic electronic part of the invention. The ceramic electronic part 100 of this embodiment is a chip-like stacked ceramic capacitor. The ceramic electronic part 100 has a roughly cuboid shape, and for example, its length in the lengthwise direction (lateral) is about 2.0 mm, and its lengths in the widthwise direction and depthwise direction are about 1.2 mm.

The ceramic electronic part 100 comprises a roughly cuboid chip element 1 and a pair of terminal electrodes 3 formed on either end face of the chip element 1. The chip element 1 has an end face 11a and end face 11b (hereinafter collectively referred to as “end faces 11”) opposing each other, a side face 13a and side face 13b (hereinafter collectively referred to as “side faces 13”) opposing each other perpendicular to the end faces 11, and a side face 15a and side face 15b (hereinafter collectively referred to as “side faces 15”) opposing each other perpendicular to the end faces 11. The side faces 13 and side faces 15 are mutually perpendicular.

The chip element 1 has a corner edge R13 between the end face 11 and the side face 13a, a corner edge R14 between the end face 11 and the side face 13b, a corner edge R15 between the end face 11 and the side face 15a, a corner edge R16 between the end face 11 and the side face 15b, a corner edge R33 between the side face 13a and the side face 15a, a corner edge R34 between the side face 15a and the side face 13b, a corner edge R35 between the side face 13b and the side face 15b, and a corner edge R36 between the side face 15b and the side face 13a.

The corner edges R13-R16 and R33-R36 are sections with a round shape (R-shape) formed by polishing the chip element 1. The R-shape can help prevent damage to the corner edges R13-R16 and R33-R36 of the chip element 1. The curvature radius of the corner edges of the chip element 1 may be, for example, 3-15% of the length in the widthwise direction of the ceramic electronic part 100.

The terminal electrodes 3 are provided covering the end faces 11, corner edge R13, corner edge R14, corner edge R15 and corner edge R16 of the chip element 1, while also integrally covering part of the end faces 11 on the side faces 13 and 15. The terminal electrodes 3 are formed covering the corners 22 of the chip element 1.

FIG. 2 is a cross-sectional view schematically showing a cut surface of the ceramic electronic part of FIG. 1 along line II-II. Specifically, FIG. 2 is a view of the cross-sectional structure of the ceramic electronic part 100 shown in FIG. 1, cut on a plane parallel to the side faces 15 and perpendicular to the side faces 13.

The terminal electrodes 3 each have a built-up structure wherein a first electrode layer 4, second electrode layer 5 and third electrode layer 6 are stacked in that order from the chip element 1 side on the end faces 11, corner edges R14-16 and corners 22. The first electrode layer 4 has a higher glass component content than the second electrode layer 5.

The first electrode layer 4 contains a glass component and a metal component comprising one or more elements selected from among Cu, Ag, Pd, Au, Pt, Fe, Zn, Al and Ni, for example. The first electrode layer 4 is formed using a conductive paste comprising a metal component, a glass component and at least one selected from among a binder, dispersing agent and solvent.

The second electrode layer 5 contains a metal component comprising one or more elements selected from among Cu, Ag, Pd, Au, Pt, Fe, Zn, Al and Ni, for example. The second electrode layer 5 is formed using a conductive paste comprising a metal component, a glass component and at least one selected from among a binder, dispersing agent and solvent. The second electrode layer 5 may also lack a glass component. The third electrode layer is a plating layer obtained by laminating a Ni layer and Sn layer, for example, and it may be formed using a plating solution. The third electrode layer is not restricted to a plating layer, and it may be a solderable electrode layer of Ag—Pt, for example.

The second electrode layer 5 is formed covering part of the end face 11 of each first electrode layer 4 on the side faces 13 and side faces 15 of the chip element 1. That is, the second electrode layer 5 is formed on the end faces 11 of the chip element 1 and on parts of the end face 11 ends of the side faces 13, 15. The second electrode layer is not formed on the other parts of the first electrode layer 4 on the side faces 13, 15 of the chip element 1. The other parts of the first electrode layer 4 are therefore not covered by the second electrode layer 5, so that they directly contact the third electrode layer 6.

The second electrode layer 5 formed on the end face 11a side of the chip element 1 extends toward the end face 11b side on the corner edges R33-R36 (FIG. 4). Thus, the corners 22 and parts of the corner edges R33-R36 of the chip element 1 are protected by a dense second electrode layer 5 with a low glass component content.

The terminal electrodes 3 in the ceramic electronic part 100 have a first electrode layer 4 with a high glass component content on side in contact with the chip element 1. Consequently, the terminal electrodes 3 and chip element 1 are bonded by sufficiently high strength so that the ceramic electronic part 100 exhibits excellent connection reliability.

The terminal electrodes 3 each have a third electrode layer 6 that covers the first electrode layer 4 and second electrode layer 5. Specifically, the third electrode layer 6 is formed covering the second electrode layer 5, on the end faces 11, corner edges R13-R16, corners 22, parts of the side faces 13, 15 on the end face 11 ends and parts of the corner edges R33-R36 on the end face 11 ends of the chip element 1. Since the third electrode layer 6 is thus formed on the second electrode layer 5, it is possible to ensure sufficient adhesiveness between the second electrode layer 5 and third electrode layer 6. On the other hand, the third electrode layer 6 is formed on the first electrode layer 4 on the parts of the side faces 13, 15 of the chip element 1 where the second electrode layer 5 is not formed on the first electrode layer 4, so that the first electrode layer 4 and third electrode layer 6 are in direct contact.

The chip element 1 comprises a plurality of dielectric layers 7 and a plurality of internal electrodes 9, alternately stacked. The direction of stacking is perpendicular to the facing direction of the pair of end faces 11 on which the terminal electrode 3 are formed, and parallel to the facing direction of the pair of side faces 13. For convenience of explanation, the number of stacked layers of the dielectric layers 7 and internal electrodes 9 in FIG. 2 is a number that can be easily shown diagrammatically, but the number of stacked layers of the dielectric layers 7 and internal electrodes 9 may be appropriately varied depending on the desired electrical characteristics. The number of stacked layers may be a sufficient number of the dielectric layers 7 and internal electrodes 9, such as about 100-500 layers, for example.

The dielectric layers 7 may be integrated to an extent that the borders between them are not visible.

The internal electrodes 9a are electrically connected to the terminal electrode 3 on one end face 11a and electrically insulated from the terminal electrode 3 on the other end face 11b. Also, the internal electrodes 9b are electrically connected to the terminal electrode 3 on one end face 11b and electrically insulated from the terminal electrode 3 on the other end face 11a. The internal electrodes 9a and internal electrodes 9b are alternately stacked between the dielectric layers 7. The ceramic electronic part 100 of this embodiment has excellent insulating reliability between the terminal electrode 3 at the end face 11a end and the internal electrodes 9b and excellent insulating reliability between the terminal electrode 3 on the end face 11b end and the internal electrodes 9a.

The terminal electrodes 3 have maximum thicknesses T and H on the end faces 11 and side faces 13. Also, the terminal electrodes 3 have thicknesses F at the extension lines of the internal electrodes 9b on the outermost sides, which extend toward the end face 11a. A conventional roughly cuboid chip element exhibits impaired insulating reliability and connection reliability due to peeling or cracking of the terminal electrodes near the corners of the chip element. From the viewpoint of ensuring excellent insulating reliability and connection reliability it is preferred to increase the thickness of the terminal electrodes near the corners (F in FIG. 2), but if the thickness is increased in a conventional ceramic electronic part, the thicknesses on the end faces and on the side faces (T and H in FIG. 2) are increased as a result, and this has often failed to satisfy the product dimension specifications.

However, since second electrode layer 5 is formed covering the end faces 11 and parts of the side faces 13, 15 at the end face 11 ends in the ceramic electronic part 100 of this embodiment, it is possible to sufficiently increase the thickness F while maintaining the size of the thickness H. It is thus possible to realize excellent insulating reliability with a sufficiently small size.

The terminal electrodes 3 preferably comprise a metal or alloy including one or more elements selected from among Cu, Ag, Pd, Au, Pt, Fe, Zn, Al, Sn and Ni. The ceramic electronic part may be considered to exhibit excellent connection reliability due to these factors. The internal electrodes 9 preferably comprise a base metal such as Ni or Cu. The dielectric layers 7 contain barium titanate, for example.

In the electronic part 100 of this embodiment, the second electrode layers 5 are formed on the end faces 11 and parts of the end face 11 ends of the side faces 13, 15 of the chip element 1, so as to cover the first electrode layers 4 that have higher glass component contents than the second electrode layers 5. Thus, stress due to differences in sintering properties of the electrode layers is reduced at the interface between each first electrode layer 4 and second electrode layer 5, such that it is possible to adequately inhibit peeling between the first electrode layer 4 and second electrode layer 5 and cracking at the fired electrode layer 8. This can satisfactorily reduce defects in each electrode layer at the corner edges R13-16 of the chip element 1.

In addition, since a dense second electrode layer with a low glass component content is formed covering the corner edges R13-R16 or corners 22, the ceramic electronic part 100 has satisfactorily excellent mechanical strength. Furthermore, since a third electrode layer 6 is formed as a plating layer on the second electrode layer with a low glass component content, it is possible to obtain sufficiently high adhesiveness between the second electrode layer 5 and third electrode layer 6. Peeling between the second electrode layer 5 and third electrode layer 6 can therefore be sufficiently inhibited. The ceramic electronic part 100 having this construction exhibits satisfactorily excellent connection reliability.

An example of a process for producing the ceramic electronic part 100 shown in FIG. 1 and FIG. 2 will now be explained. The process for producing the ceramic electronic part 100 comprises a chip element-forming step, a conductive green sheet-forming step, a conductive paste bonding step, a conductive sheet attachment step, a drying step, an electrode firing step and a plating step. Each step will now be described in detail.

A chip element 1 is formed in the chip element-forming step. For formation of the chip element 1, first a ceramic green sheet is formed for the dielectric layer 7. The ceramic green sheet may be formed by coating a PET film with a ceramic slurry by doctor blading or the like and then drying it. The ceramic slurry may be obtained by adding a solvent and a plasticizer to a dielectric material composed mainly of barium titanate, for example, and mixing. An electrode pattern for the internal electrodes 9 is screen printed onto the formed ceramic green sheet and dried. Screen printing of the electrode pattern may be accomplished using an electrode paste obtained by combining a binder or a solvent with Cu powder or Ni powder.

A plurality of electrode patterned green sheets are formed in this manner and stacked. Next, the stack of electrode patterned green sheets is cut perpendicular to the stacking direction to form a cuboid stacked chip, and it is heat treated for binder removal. The heat treatment is preferably carried out at 180-400° C. for 0.5-30 hours. The stacked chip obtained by heat treatment is fired at 800-1400° C. for 0.5-8.0 hours, and subjected to barrel polishing for chamfering to create cuboid corner edges with a round shape. A chip element 1 can be obtained in this manner.

A conductive green sheet is formed in the conductive green sheet-forming step. Specifically, a PET (polyethylene terephthalate) film was coated with a conductive green sheet paste to a thickness of about 70 μm. The conductive green sheet paste used may be a mixture of a powder of a metal or alloy containing Cu, Ag, Pd, Au, Pt, Fe, Zn, Al or Ni, a resinous binder and an organic solvent.

Next, the paste coated onto the PET film is dried to form a conductive green sheet. The dried conductive green sheet contains residual organic components. The thickness of the conductive green sheet may be about 10-50 μm.

The conductive green sheet is cut to a desired size on the PET film to form a conductive green sheet 31 (FIG. 3). The conductive green sheet 31 is cut so that the pasting surface which is to be pasted to the chip element 1 is a slightly larger size than the end faces 11 of the chip element 1. For example, if both the end faces 11 and the side conductive green sheet 31 attachment side are square, the size of the conductive green sheet is preferably 100-150% based on the area of the end faces 11. After cutting, the PET film may be released to obtain a conductive green sheet 31.

In the conductive paste bonding step, a conductive paste is bonded to the chip element 1. The conductive paste used may be one obtained by adding glass frit to a component comprising a conductive green sheet paste. One end face 11a of the chip element 1 is faced downward while dipping the end face 11a, the corner edges R13-R16 and parts of the side faces 13, 15 at the end face 11a end into the conductive paste. This bonds the conductive paste to the end face 11a, the corner edges R13-R16 and the parts of the side faces 13, 15 at the end face 11 ends of the chip element 1.

FIG. 3 shows the state of the conductive paste 33 bonded to the chip element 1. FIG. 3 is a cross-sectional process diagram schematically showing the conductive paste bonding step and the conductive sheet attachment step. As shown in FIG. 3, the conductive paste 33 is bonded to the end face 11a, the corner edges R13-R16 and the parts of the side faces 13, 15 at the end face 11a end of the chip element 1 in the conductive paste-bonding step.

In the conductive sheet attachment step, one side 31s of the conductive green sheet 31 is attached to the end face 11a of the chip element 1, as shown in FIG. 3. That is, the chip element 1 is pressed onto the conductive green sheet 31 with one end face 11a of the chip element 1, to which the conductive paste 33 has been bonded, facing the side 31s of the conductive green sheet 31.

When the conductive green sheet 31 is attached onto the end face 11a of the chip element 1, the conductive paste 33 bonded to the end face 11a of the chip element 1 is pressed from the center of the end face 11a toward the edges of the end face 11a, thus bonding the conductive green sheet 31 and the chip element 1 via the conductive paste 33.

During bonding, the organic solvent in the conductive paste 33 permeates to the dried conductive green sheet 31, thus dissolving the residual organic components in the conductive green sheet 31. As a result, the conductive green sheet 31 becomes flexible and deforms along the corner edges R13-R16 and corners 22 of the chip element 1 to integrate the conductive green sheet 31 and conductive paste 33. The residual organic components in the conductive green sheet 31 may include, for example, the binder in the conductive green sheet paste.

In the drying step, the conductive paste 33 bonded to the chip element and the conductive green sheet 31 are dried to form a conductive layer comprising two layers with different glass component contents. The conductive paste 33 and conductive green sheet 31 are dried with the end face 11 a side of the chip element 1 facing downward.

Since the conductive paste 33 has a higher organic solvent content ratio than the conductive green sheet 31, the shrinkage factor with volatilization of the organic solvent during the drying process is greater than that of the conductive green sheet 31. As drying proceeds, therefore, the conductive green sheet 31 deforms along the corner edges R13-R16 and the corners 22.

The side 31s of the conductive green sheet 31 has a slightly larger size than the end faces 11 of the chip element 1. In the drying step, therefore, the edges along the outer periphery of the conductive green sheet 31 deform so as to cover parts of the side faces 13, 15 at the end face 11a end. This forms a conductive layer having two layers with different glass component contents.

The integration and adhesiveness of the conductive paste 33 and conductive green sheet 31 may be adjusted by, for example, varying the binder content in the paste.

Next, the conductive paste bonding step, conductive sheet attachment step and drying step are carried out for the end face 11b end of the chip element 1, in the same manner as the end face 11a end.

This forms a conductive layer on the end face 11b end of the chip element 1, in the same manner as the end face 11a end.

In the electrode firing step, the conductive layers formed on the end faces 11 and side faces 13, 15 are fired to form a fired electrode layer 8. The firing is carried out at, for example, 400-850° C. for 0.2-5.0 hours. The firing reduces the thickness of the conductive paste 33 bonded onto the side faces 13, 15 of the chip element 1. Upon firing, a chip component 110 as shown in FIG. 4 is obtained.

FIG. 4 is an oblique view of a chip component 110 having fired electrode layers 8 formed on both end faces of a chip element 1. The fired electrode layer 8 has a built-up structure obtained by stacking the first electrode layer 4 and second electrode layer 5, in that order from the chip element 1 side, on the end faces 11 and parts of the end face 11 ends of the side faces 13, 15 of the chip element 1. Since the first electrode layer 4 has a higher glass component content than the second electrode layer 5, the chip element 1 and the fired electrode layer 8 are firmly bonded by the first electrode layer 4. On the other hand, the second electrode layer 5 has a lower glass component and is therefore denser than the first electrode layer 4. It is thus possible to satisfactory prevent erosion of the chip element 1 by the plating solution in the plating step described below.

The plating step is a step in which the fired electrode layer 8 of the chip component 110 is subjected to electroplating to form a third electrode layer 6 as a plating layer on the fired electrode layer 8. The plating layer can be obtained by a method of sequential formation of a Ni plating layer and Sn plating layer by barrel plating using a Ni plating bath (for example, a Watt bath) and a Sn plating bath (for example, a neutral Sn plating bath).

The plating step produces a terminal electrode 3 comprising a first electrode layer 4, second electrode layer 5 and third electrode layer 6, as shown in FIG. 2. Since the plating layer as the third electrode layer 6 is thinly formed along the surface of the fired electrode layer 8, the terminal electrode 3 and fired electrode layer 8 have the same shape. The ceramic electronic part 100 can be produced by a production process comprising these steps.

The term “roughly cuboid shape” used in this embodiment refers not only to a cube shape or cuboid shape, but also includes shapes with round-shaped corner edges, formed by chamfering the corner edge sections of a cuboid. That is, the chip element of this embodiment may have an shape that is essentially cubical or cuboid.

The embodiments described above are only preferred embodiments of the invention, and the invention is in no way limited thereto. For example, the ceramic electronic part 100 was explained as a condenser for this embodiment, but this is not limitative. The ceramic electronic part of the invention may also be a varistor, inductor or LCR. The chip element 1 may also be a varistor layer or magnetic layer instead of the dielectric layer 7 described above.

### EXAMPLES

The present invention will now be explained in greater detail based on examples and comparative examples, with the understanding that these examples are in no way limitative on the invention.

### Example 1

### <Formation of Chip Element>

A ceramic slurry was prepared by mixing conventional BaTiO₃ powder, a binder, an organic solvent and a plasticizer. The ceramic slurry was coated onto a PET film by a doctor blading method and then dried to form a ceramic green sheet.

The formed ceramic green sheet was screen printed with an electrode paste obtained by mixing a binder or solvent with Cu powder or Ni powder and drying it to form an electrode patterned green sheet.

The same method was repeated to form multiple electrode patterned green sheets in layers, to fabricate a stack. Next, the stack of electrode patterned green sheets was cut perpendicular to the stacking direction to form a cuboid stacked chip, and it was heat treated for binder removal. The heat treatment was at 180-400° C. for 0.5 hour or longer. The stacked chip obtained by heat treatment was fired at 800-1400° C. for 0.5-8.0 hours, and subjected to barrel polishing for chamfering to create cuboid corner edges in an R-shape, thereby obtaining a chip element 1 with a roughly cuboid shape (FIG. 3).

### <Formation of Conductive Green Sheet>

A paste was prepared by mixing commercially available Cu powder, a resinous binder and an organic solvent. The paste was coated onto a commercially available PET film and dried, and cut to a prescribed size to obtain a conductive green sheet. The side which was attached to the end face of the chip element of the conductive green sheet (the main side) was similar in shape to the end face of the chip element of the conductive green sheet (square), and the size of the main side was 100-150% of the size of the end face.

### <Fabrication of Chip Component 110>

A conductive paste was prepared comprising commercially available Cu powder, a resinous binder, glass frit and an organic solvent. One end face of the chip element formed in the manner described above was faced downward while dipping the end face, the corner edges adjacent to the end face and parts of the side faces at the end face end into the conductive paste. This bonded the conductive paste 33 onto one end face 11a of the chip element 1, the corner edges and the end face ends of the side faces, as shown in FIG. 3.

Next, as shown in FIG. 3, the chip element 1 was pressed against the conductive green sheet 31 with one end face 11 a of the chip element 1 facing one side 31s of the conductive green sheet 31 across the conductive paste 33, for attachment of the conductive green sheet to the end face 11a. Next, the conductive paste 33 and the conductive green sheet 31 were dried to form a conductive layer comprising two layers with different glass component contents. The perimeter of the conductive green sheet deformed along the outer periphery, forming a conductive layer covering the parts of the side faces 13, 15 at the end face 11a end, the corner edges R13-R16 and the corners 22. The conductive green sheet 31 was provided on the side faces 13, 15 so as to cover part of the conductive paste 33 bonded to the chip element 1, and was dried to form a conductive layer.

A conductive layer was then formed on the end face 11b end of the chip element 1, in the same manner as the end face 11a end.

Next, the conductive layers formed on the end faces 11 and the side faces 13,15 of the chip element 1 were fired in an electric furnace under conditions of 400-850° C. for 0.2-5.0 hours, to fabricate a chip component 110 having fired electrode layers 8 as the terminal electrodes, as shown in FIG. 4.

The fired electrode layer 8 had a built-up structure obtained by stacking the first electrode layer 4 and second electrode layer 5, in that order from the chip element 1 side, on the end faces 11 and parts of the end face 11 ends of the side faces 13, 15 of the chip element 1. Also, the first electrode layer 4 has sections not covered by the second electrode layer 5, on the side faces 13, 15 of the chip element 1.

The thickness of the fired electrode layer 8 of the chip component 110 fabricated as described above was measured in the following manner. First, the chip component 110 shown in FIG. 4 was cut along line V-V and the thickness of the fired electrode layer 8 at the cut surface was measured by observation with a microscope.

FIG. 5 is a cross-sectional view schematically showing a cut surface of the chip component 110 of FIG. 4 along line V-V. That is,

FIG. 5 is a schematic cross-sectional view of the chip component 110 cut perpendicular to the end faces 11 and in a plane passing through the pair of corners 22 at the diagonals of the end faces 11.

Table 1 shows the results of measuring the maximum thickness, where the maximum thickness of the terminal electrode on the end faces 11 is represented as T1, the maximum thickness at the extension line which is not exposed on one end face and extends to the end face of the internal electrode 9 on the outermost side is represented as F1 and the maximum thickness at the corner edges R34, R36 is represented as H1, in the cross-section shown in FIG. 5.

Next, a separate chip component 110 with the same structure fabricated by the same production process was cut on the plane parallel to the end faces 11 and passing through the ends of the internal electrodes 9 on the side not exposed at the end face, to obtain a cut surface as shown in FIG. 6. FIG. 6 is a cross-sectional view schematically showing a cut surface of the chip component 110 parallel to the end faces 11, and running through the ends of the internal electrode 9 which are not exposed at the end face. The thickness of the fired electrode layer 8 at the cut surface was observed with an electron microscope. Table 1 shows the results of measurement with the maximum thickness of the fired electrode layer 8 on the side faces 13, 15 represented as H2 and the minimum thickness of the fired electrode layer 8 on the corner edges R33-R36 represented as r.

### <Fabrication of Chip Capacitor 100>

A Ni plating layer was formed by Ni plating on the fired electrode layer 8 of the chip component 110 by barrel plating, and then a Sn plating layer was formed by Sn plating, to form a plating layer 6 with the Ni plating layer and Sn plating layer stacked in that order from the chip element side. This produced a chip capacitor 100 having the shape shown in FIG. 1 and FIG. 2.

The insulating reliability of the chip capacitor 100 was evaluated in the following manner. First, the initial insulation resistance (R₀) between opposing terminal electrodes was measured. Next, a voltage of 6.3 V was applied between the opposing terminal electrodes at a temperature of 85° C. for 1000 hours, and the insulation resistance (R₁) after voltage application was measured. A ratio of R₁ to R₀ (R₁/R₀) of below 1/100 was judged as “NG”. A total of 100 chip capacitors 100 fabricated by the same production process were prepared and their insulation resistances were measured. The number of chip capacitors judged as “NG” are listed in Table 1.

### Comparative Example 1

A chip element was fabricated in the same manner as Example 1, and one end face of the chip element, the corner edges adjacent to the end face and parts of sides at the end face ends were dipped into the same conductive paste as Example 1, to bond the conductive paste onto the end face, the corner edges and the parts of the sides at the end face ends of the chip element. The conductive paste-bonded chip element was dried to form a conductive layer. A conductive layer was formed in the same manner on the other end face of the chip element.

Next, the conductive layers formed on the end faces and the side faces of the chip element were fired in an electric furnace under conditions of 400-850° C. for 0.2-5.0 hours, to fabricate a chip component having fired electrode layers as the terminal electrodes. The chip component had only one electrode layer formed using the paste, as the terminal electrode.

The thicknesses of the fired electrode layers of the chip component were measured in the same manner as Example 1. The measurement results were as shown in Table 1.

A plating layer was formed on the chip component in the same manner as the “fabrication of the chip capacitor 100” in Example 1. The chip capacitor thus obtained comprised a terminal electrode with a two-layer structure, comprising a stack of one electrode layer formed on parts of the sides at both end face ends and on the end faces using paste, and one electrode layer comprising a plating layer covering the entire surface of that electrode layer. The insulating reliability of the chip capacitor was evaluated in the same manner as Example 1. The results were as shown in Table 1.

### Comparative Example 2

A chip element was fabricated in the same manner as Example 1, and one end face of the chip element, the corner edges adjacent to the end face and parts of sides at the end face ends were dipped into the same conductive paste as Example 1. The conductive paste-bonded chip element was dried to form a conductive layer. Next, the chip element was dipped into the conductive paste in the same manner to bond the paste, so as to cover the entire conductive layer. It was dried, and then repeatedly dipped and dried, to form a conductive layer with a built-up structure on one end face, the corner edges and parts of the sides at the end face ends of the chip element 1. A conductive layer was formed in the same manner on the other end face of the chip element as well.

Next, the conductive layers formed on the end faces and the side faces of the chip element were fired in an electric furnace under conditions of 400-850° C. for 0.2-5.0 hours, to fabricate a chip component having fired electrode layers with 3 stacked electrode layers, as the terminal electrodes.

The thicknesses of the fired electrode layers of the chip component were measured in the same manner as Example 1. The evaluation results were as shown in Table 1.

A plating layer was formed on the chip component in the same manner as the “fabrication of the chip capacitor 100” in Example 1. The chip capacitor thus obtained comprised a terminal electrode with a four-layer structure, comprising a stack of three electrode layers formed on parts of the sides at both end face ends and on the end faces using paste, and one electrode layer comprising a plating layer covering the entire surface of that electrode layer. The insulating reliability of the chip capacitor was evaluated in the same manner as Example 1. The results were as shown in Table 1.

TABLE 1

| | | Comparative | Comparative |
|---|---|---|---|
| | Example 1 | Example 1 | Example 2 |
| Thickness T1 (μm) | 27.2 | 50.4 | 56.8 |
| Thickness H1 (μm) | 23.5 | 10.7 | 23.3 |
| Thickness F1 (μm) | 17.8 | 3.3 | 16.2 |
| Thickness H2 (μm) | 33.1 | 21.2 | 34.3 |
| Thickness r (μm) | 9.3 | 2.3 | 8.1 |
| Insulating reliability | 0 | 68 | 3 |
| evaluation | | | |
| (Number of NG) | | | |

As seen in Table 1, excellent insulating reliability was exhibited by the chip capacitor of Example 1 having the second electrode layer 5 formed on the outside, covering parts of the inside first electrode layer 4, on the side faces of the chip element. The thickness difference of the fired electrode layers on the chip element was sufficiently reduced, demonstrating that both insulating reliability and size reduction can be satisfactorily achieved.

The chip capacitor of Comparative Example 1, on the other hand, has low insulating reliability. This is thought to be due to deterioration by permeation of the plating solution as a result of the small thickness F1 or thickness r, despite the large thickness T1.

Since the thickness of the entire fired electrode layer was larger in the chip capacitor of Comparative Example 2 than in Comparative Example 1, it was possible to increase the thickness F1 or thickness r and inhibit some of the deterioration due to permeation of the plating solution. However, it was confirmed that the large thickness T1 hampered efforts to achieve sufficient size reduction. It was also found that the insulating reliability was poorer than in Example 1.

What is claimed is:

1. A ceramic electronic part comprising:
a chip element having internal electrodes embedded therein; and
terminal electrodes that cover the end faces of the chip element having exposed internal electrodes and parts of the sides orthogonal to the end faces, and that are electrically connected to the internal electrodes,
wherein the terminal electrodes comprise a first electrode layer and a second electrode layer with a lower glass component content than the first electrode layer, in that order from the chip element side,
the second electrode layer being formed covering part of the first electrode layer on the side faces.

2. A ceramic electronic part according to claim 1, wherein the terminal electrodes have a third electrode layer that covers the first electrode layer and second electrode layer.

3. A ceramic electronic part according to claim 1, wherein the terminal electrode has a second electrode layer on the corners of the chip element.

4. A ceramic electronic part according to claim 2, wherein the terminal electrode has a second electrode layer on the corners of the chip element.

5. A ceramic electronic part according to claim 1, wherein the second electrode layer is formed at the corner edges between the side faces orthogonal to one end face and mutually adjacent, extending to the other end face.

6. A ceramic electronic part according to claim 2, wherein the second electrode layer is formed at the corner edges between the side faces orthogonal to one end face and mutually adjacent, extending to the other end face.

7. A ceramic electronic part according to claim 3, wherein the second electrode layer is formed at the corner edges between the side faces orthogonal to one end face and mutually adjacent, extending to the other end face.

8. A ceramic electronic part according to claim 4, wherein the second electrode layer is formed at the corner edges between the side faces orthogonal to one end face and mutually adjacent, extending to the other end face.

9. A ceramic electronic part according to claim 1, wherein the terminal electrodes contain one or more elements selected from among Cu, Ag, Pd, Au, Pt, Fe, Zn, Al, Sn and Ni.
